(19) United States
(12) Patent Application Publication
(10) Pub. No.: US 2024/0084191 A1
(43) Pub. Date: Mar. 14, 2024

(54) HYDRAULIC FRACTURING WITH DENSITY-TUNABLE AQUEOUS HEAVY FRACTURING FLUIDS

(71) Applicant: ExxonMobil Technology and Engineering Company, Spring, TX (US)

(72) Inventors: Timothy J. NEDWED, Houston, TX (US); Dragan STOJKOVIC, Spring, TX (US); Lee J. HALL, The Woodlands, TX (US); P. Matthew SPIECKER, Manvel, TX (US)

(21) Appl. No.: 18/451,259

(22) Filed: Aug. 17, 2023

Related U.S. Application Data
(60) Provisional application No. 63/404,603, filed on Sep. 8, 2022.

(51) Int. Cl. C09K 8/66; C09K 8/68; C09K 8/80; E21B 43/267

(52) U.S. Cl. CPC C09K 8/665; C09K 8/66; C09K 8/68; C09K 8/80; E21B 43/267

(57) ABSTRACT

A slurry including a density-tunable aqueous heavy fracturing fluid and a method for completing a hydrocarbon well using such a slurry are provided herein. The slurry includes proppant particulates and the density-tunable aqueous heavy fracturing fluid, where the density-tunable aqueous heavy fracturing fluid includes a bromide-based compound. The density of the density-tunable aqueous heavy fracturing fluid is between 1 gram/cubic centimeter (g/cc) and 3.6 g/cc.

### CROSS-REFERENCE TO RELATED APPLICATION

This application claims the benefit of U.S. Provisional Application Ser. No. 63/404,603, entitled “HYDRAULIC FRACTURING WITH DENSITY-TUNABLE AQUEOUS HEAVY FRACTURING FLUIDS,” filed Sep. 8, 2022, the disclosure of which is hereby incorporated by reference in its entirety.

### FIELD OF THE INVENTION

The techniques described herein relate to the field of subterranean hydraulic fracturing operations. More specifically, the techniques described herein relate to density-tunable aqueous heavy fracturing fluids and methods for utilizing such fracturing fluids during hydraulic fracturing operations.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

A wellbore may be drilled into a subterranean formation to promote the removal (or production) of a hydrocarbon resource from a hydrocarbon-bearing interval (or reservoir) of the formation. In many cases, the subterranean formation needs to be stimulated in some manner to promote the removal of the hydrocarbon resource. Stimulation operations include any operation performed on the matrix of the subterranean formation to improve hydraulic conductivity within the matrix. Such stimulation operations include hydraulic fracturing operations, which are commonly used to stimulate unconventional reservoirs (e.g., shale or loose sandstone).

Hydraulic fracturing operations involve pumping large quantities of fracturing fluid into a subterranean formation under high hydraulic pressure to promote the formation of fractures within the matrix of the subterranean formation and create high-conductivity flow paths. Primary fractures extending from the wellbore and, in some instances, secondary fractures extending from the primary fractures, possibly dendritically, may be formed during a fracturing operation. These fractures may be vertical, horizontal, or a combination of directions forming a tortuous path.

Proppant particulates are often included in a fracturing fluid in order to prop the fractures open after the hydraulic pressure has been released following the hydraulic fracturing operation. More specifically, upon reaching the fractures, the proppant particulates settle within the fractures to form a proppant pack that prevents the fractures from closing once the hydraulic pressure has been released. In this manner, the proppant particulates provide a long-term increase in fluid permeability and conductivity within the fractured region of the formation.

In some instances, conventional fracturing fluid materials may not effectively maximize propped fracture surface area. In particular, there are oftentimes difficulties encountered during hydraulic fracturing operations associated with the deposition of proppant particulates in fractures. Conventional proppant particulates, which are commonly formed from sand and/or ceramic particles, are often fairly dense materials and tend to settle quickly within a near-perforation region of a fracture, thus accumulating within close proximity to the wellbore and leaving much of the extended region of the fracture unpropped. This, in turn, results in limited production from the resulting low-conductivity, partly-unpropped fractures. Moreover, as a result, larger quantities of proppant and fracturing fluid are required to push the proppant as far into the fractures as possible.

This problem is caused, at least in part, by the high settling velocity of conventional proppants within conventional fracturing fluids, where such settling velocity is directly correlated to the density difference between the proppant and the fracturing fluid. Specifically, a higher density difference between the proppant and the fracturing fluid results in a higher settling velocity for the proppant.

One technique for addressing this problem is to reduce the particle size of the proppant particulate. However, smaller sand particle sizes result in lower porosities and permeabilities within the resulting proppant packs and can result in fine-grained particles (referred to as “fines”) produced from crushing of proppant particulates that can lessen fluid conductivity, which may decrease production rates and/or necessitate wellbore cleanout operations. As a result, there is a practical lower limit for the sand particle size. Another technique is to utilize unconventional, lightweight (or low-density) proppant particulates to reduce settling velocity within the fracturing fluid by reducing the density difference between the proppant and the fracturing fluid. However, such lightweight proppant particulates are generally more expensive than conventional proppant particulates. Moreover, such lightweight proppant particulates have the potential to negatively impact the porosity and/or permeability of formed proppant packs after months and years of being soaked with hydrocarbons. Yet another technique is to increase the viscosity of otherwise conventional low-viscosity aqueous fracturing fluid, such as by using gels. However, gels have the potential to negatively impact the permeability of both the rock faces and the proppant packs.

### SUMMARY OF THE INVENTION

This application relates to fracturing operations, and, in particular, to density-tunable aqueous heavy fracturing fluids and methods related thereto.

In nonlimiting aspects of the present disclosure, a slurry for propping fractures within a subterranean region is provided. The slurry includes proppant particulates and a density-tunable aqueous heavy fracturing fluid comprising an aqueous carrier fluid and at least a bromide-based compound. The density of the density-tunable aqueous heavy fracturing fluid is selected based on a density of the proppant particulates such that density of the density-tunable aqueous heavy fracturing is within 20% of the density of the proppant particulates.

In nonlimiting aspects of the present disclosure, a method for completing a hydrocarbon well using a density-tunable aqueous heavy fracturing fluid is provided. The method includes flowing a slurry comprising a density-tunable aqueous heavy fracturing fluid and proppant particulates into a wellbore to prop fractures with the proppant particulates, wherein the density-tunable aqueous heavy fracturing fluid comprises an aqueous carrier fluid and at least a bromide-based compound, wherein a density of the density-tunable aqueous heavy fracturing fluid is selected based on a density of the proppant particulates such that density of the density-tunable aqueous heavy fracturing is within 20% of the density of the proppant particulates. The slurry comprising the density-tunable aqueous heavy fracturing fluid is returned to a wellhead of the wellbore, and at least a portion of the density-tunable aqueous heavy fracturing fluid is recovered from the slurry.

In nonlimiting aspects of the present disclosure, a method for completing a hydrocarbon well using a density-tunable aqueous heavy fracturing fluid is provided. The method includes positioning a perforation device within a tubular conduit of a downhole tubular extending through a wellbore within a subsurface region and perforating the downhole tubular using the perforation device to define perforations within the downhole tubular. A conventional fracturing fluid is pumped into the tubular conduit to fracture areas of the subsurface region that are proximate to the perforations, forming corresponding fractures within the subsurface region. A slurry comprising the conventional fracturing fluid and first proppant particulates into the fractures, via the perforations, to prop the fractures with the first proppant particulates. A slurry comprising the density-tunable aqueous heavy fracturing fluid and second proppant particulates is flowed into the fractures, via the perforations, to further prop the fractures with the second proppant particulates, wherein the aqueous density-tunable aqueous heavy fracturing fluid comprises an aqueous carrier fluid and at least a bromide-based compound, and wherein a density of the density-tunable aqueous heavy fracturing fluid is higher than a density of the conventional fracturing fluid, and wherein the density of the density-tunable aqueous heavy fracturing fluid is selected based on a density of the proppant particulates such that density of the density-tunable aqueous heavy fracturing is within 20% of the density of the proppant particulates. The slurry comprising the aqueous density-tunable aqueous heavy fracturing fluid and the conventional fracturing fluid is returned to a wellhead of the wellbore and at least a portion of the density-tunable aqueous heavy fracturing fluid is recovered from the slurry.

These and other features and attributes of the disclosed petroleum coke proppant particulates of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a schematic view of an exemplary hydrocarbon well that is initially completed using the conventional fracturing fluid.

FIG. 2 is another schematic view of the exemplary hydrocarbon well of FIG. 1, which is further completed using the density-tunable aqueous heavy fracturing fluid described herein.

FIG. 3 is a process flow diagram of an exemplary method for completing a hydrocarbon well using the density-tunable aqueous heavy fracturing fluid described herein.

The figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION

This application relates to fracturing operations, and, in particular, to density-tunable aqueous heavy fracturing fluids and methods related thereto.

As discussed above, proppant particulates can be used effectively during fracturing operations, but there may be issues associated with their use. Particularly, the high densities of typical proppant particulates (e.g., sand having a density of about 2.65 grams per cubic centimeter (g/cc)) may hinder their transport, possibly leading to inadequate proppant particulate disposition within one or a plurality of fractures. Because traditional fracturing fluid has a much lower density (e.g., slickwater or brine having a density of about 1.0 to 1.2 g/cm 3), these traditional proppant particulates have particularly high settling velocities. Ultralight proppant, with density very close to the density of traditional fracturing fluid will stay suspended therein much longer compared to higher density traditional (e.g., sand) proppant particulates. However, available ultra-light proppant options are either much more expensive than traditional proppant particulates, or have a comparably significantly lower compressive strength and hydraulic conductivity.

The present disclosure alleviates the foregoing difficulties and provides related advantages as well. In particular, the present disclosure provides density-tunable aqueous heavy fracturing fluids composed at least partially of a bromide-based compound capable of influencing the density of traditional proppant particulates to reduce scale velocity thereof. The density-tunable aqueous heavy fracturing fluids comprising at least a bromide-based compound of the present disclosure advantageously provide high-density fracturing fluid solutions that are non-damaging to formations and low in cost.

### Definitions

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., up to ±5%. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated, to those entities specifically identified. Thus, as a non-limiting example, “at least one of A or B” (or, equivalently, “at least one of A and B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “fluid” refers to gases and liquids, as well as to combinations of gases and liquids, combinations of gases and solids, combinations of liquids and solids, and combinations of gases, liquids, and solids.

The use of the noun “fracture” refers to a crack or surface of breakage induced by an applied pressure or stress within a subsurface formation.

The use of the verb “fracture” means to perform a stimulation treatment, such as a hydraulic fracturing treatment, which is routine for hydrocarbon wells in low-permeability reservoirs. Specially-engineered fracturing fluids are pumped at high pressures and rates into the reservoir interval to be treated, causing fractures to open. The wings of the fractures extend away from the wellbore in opposing directions according to the natural stresses within the formation. The characteristics of different fractures and fracture networks have a significant impact on a reservoir's production capability.

The term “fracturing fluid” generally refers to a fluid that is injected into a hydrocarbon well as part of a stimulation operation, typically comprising a flowable fluid, proppant particulates, and one or more optional additives. The term “conventional fracturing fluid” is used herein to refer to slickwater or any other commercially-available fracturing fluid with a density of 1.2 g/cc or less. Slickwater is one of the most commonly-used fracturing fluids and is mostly water with a small amount, i.e., about 1%, of friction reducers and other fluids (usually shear thinning, non-Newtonian solutions, gels, or emulsions). The friction reducers and other fluids allow for a faster pumping rate into a reservoir, leading to an increase in the numbers and sizes of the fractures formed. The term “density-tunable aqueous heavy fracturing fluid” refers to an aqueous flowable carrier fluid (including slickwater) that comprises at least one or more soluble compounds.

As used herein, the term “hydraulic conductivity” refers to the ability of a fluid within a formation to pass through a fracture including proppant particulates at various stress (or pressure) levels, which is based, at least in part, on the permeability of the resultant proppant packs deposited within the fractures.

The term “hydraulic fracturing” refers to a process for creating fractures that extend from a wellbore into a reservoir, so as to stimulate the flow of hydrocarbon fluids from the reservoir into the wellbore.

A “hydrocarbon” is an organic compound that primarily includes the elements hydrogen and carbon, although nitrogen, sulfur, oxygen, metals, or any number of other elements may be present in relatively small amounts. As used herein, the term “hydrocarbon” generally refers to components found in natural gas, oil, or chemical processing facilities. Moreover, the term “hydrocarbon” may refer to components found in raw natural gas, such as CH₄, C₂H₆, C₃ isomers, C₄ isomers, benzene, and the like.

As used herein, the term “proppant particulate” or simply “proppant” refers to any suitable material that is capable of maintaining an open and induced fracture within a formation during and following a hydraulic fracturing treatment for a corresponding wellbore.

“Subterranean formation” (also referred to as “subsurface formation” or simply “formation”) refers to a subsurface region including an aggregation of subsurface sedimentary, metamorphic, and/or igneous matter, whether consolidated or unconsolidated, and other subsurface matter, whether in a solid, semi-solid, liquid, and/or gaseous state, related to the geological development of the subsurface region. A formation can be a body of geologic strata of predominantly one type of rock or a combination of types of rock, or a fraction of strata having substantially common sets of characteristics. A formation can contain one or more hydrocarbon-bearing intervals, generally referred to as “reservoirs.” Note that the terms “formation,” “reservoir,” and “interval” may be used interchangeably, but may generally be used to denote progressively smaller subsurface regions, stages, or volumes. More specifically, a “formation” may generally be the largest subsurface region, while a “reservoir” may generally be a hydrocarbon-bearing stage or interval within the geologic formation that includes a relatively high percentage of oil and gas. Moreover, an “interval” may generally be a sub-region or portion of a reservoir. In some cases, a hydrocarbon-bearing stage, or reservoir, may be separated from other hydrocarbon-bearing stages by stages of lower permeability, such as mudstones, shales, or shale-like (i.e., highly-compacted) sands.

The term “near-perforation region,” when used in reference to a fracture within a subsurface region, refers to a portion of the fracture that is within close proximity to corresponding perforation(s), such as, for example, within 5 feet, within 10 feet, within 15 feet, or within 20 feet of the perforation(s). In addition, the term “near-perforation region” may also refer to the actual perforations (or perforation tunnels) corresponding to the fracture.

The term “extended region,” when used in reference to a fracture within a subsurface region, refers to a portion of the fracture that is beyond the near-perforation region, such as the region beginning about 20 feet to about 50 feet from the corresponding perforation(s) and extending substantially the entire length of the fracture (or some substantial portion thereof, such as, for example, around 70% to around 90% of the total length of the fracture).

As used herein, the term “surface” refers to the uppermost land surface of a land well, or the mud line of an offshore well, while the term “subsurface” (or “subterranean”) refers to a geologic strata occurring below the earth's surface. Moreover, as used herein, “surface” and “subsurface” are relative terms. The fact that a particular piece of equipment is described as being on the surface does not necessarily mean it must be physically above the surface of the earth but, rather, describes only the relative placement of the surface and subsurface pieces of equipment. In that sense, the term “surface” may generally refer to any equipment that is located above the casing strings and other equipment that is located inside the wellbore. Moreover, according to embodiments described herein, the terms “downhole” and “subsurface” may be used interchangeably, although the term “downhole” is generally used to refer specifically to the inside of the wellbore.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “wellbore” refers to a borehole drilled into a subterranean formation. The borehole may include vertical, deviated, highly deviated, and/or horizontal sections. The term “wellbore” also includes the downhole equipment associated with the borehole, such as casing strings, production tubing, artificial/gas lift valves, and other subsurface equipment. Relatedly, the term “hydrocarbon well” (or simply “well”) includes the wellbore in addition to the wellhead and other associated surface equipment.

The term “artificial lift” or “gas lift” refers to a method of gas injection into a wellbore in order to cause fluid(s) within the wellbore to rise toward the surface. The method is used to lower the bottom hole pressure on the formation to obtain a higher production rate of fluids within a wellbore to the surface.

As used herein, the term “petroleum coke” is used to refer to delayed coke, fluid coke, and/or Flexicoke, each of which may be used as an unconventional proppant particulate.

Fluid coking is a carbon rejection process that is used for upgrading heavy hydrocarbon feeds and/or feeds that are challenging to process. The process produces a variety of lighter, more valuable liquid hydrocarbon products, as well as a substantial amount of fluid coke as byproduct. The fluid coke byproduct comprises high carbon content and various impurities. The fluid coking process may be manipulated to obtain fluid coke having the distinctive characteristics described herein that are suitable for use as proppant particulate material, including as a supplement or replacement to traditional proppant particulate material.

Flexicoke is produced from a modified variation of fluid coking, termed FLEXICOKING™ (trademark of ExxonMobil Research and Engineering Company (“ExxonMobil”)). FLEXICOKING™ is based on fluidized bed technology developed by ExxonMobil, and is a carbon rejection process that is used for upgrading heavy hydrocarbon feeds (referred to as “residual”). Unlike fluid coking, which utilizes a reactor and a burner, the FLEXICOKING™ process uses a reactor, a heater, and a gasifier.

Certain embodiments and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by those skilled in the art.

Furthermore, concentrations, dimensions, amounts, and/or other numerical data that are presented in a range format are to be interpreted flexibly to include not only the numerical values explicitly recited as the limits of the range, but also all individual numerical values or sub-ranges encompassed within that range, as if each numerical value and sub-range were explicitly recited. For example, a disclosed numerical range of 1 to 200 should be interpreted to include, not only the explicitly-recited limits of 1 and 200, but also individual values, such as 2, 3, 4, 197, 198, 199, etc., as well as sub-ranges, such as 10 to 50, 20 to 100, etc.

As described above, conventional techniques for propping fractures with proppant particulates during hydraulic fracturing operations may not be highly effective at propping extended regions of fractures while also maintaining high porosity and permeability within the resulting proppant packs. Accordingly, various aspects of the present disclosure provide an enhanced fracturing fluid (referred to herein as a “density-tunable aqueous heavy fracturing fluid”) including an aqueous carrier fluid comprising one or more soluble compounds, as well as techniques for utilizing such fracturing fluid during hydraulic fracturing operations to provide for effective placement of proppant particulates within the extended regions of fractures while maintaining high porosity and permeability within the resulting proppant packs. As described further herein, this is achieved, at least in part, by selecting the density of the density-tunable aqueous heavy fracturing fluid based on the density of the proppant particulates and then adjusting the density of the density-tunable aqueous heavy fracturing fluid to achieve a specified settling velocity for the proppant particulates within the slurry.

The hydraulic fracturing techniques described herein, which utilize the density-tunable aqueous heavy fracturing fluid described herein during at least a portion of a hydraulic fracturing process, provide a number of advantages over conventional hydraulic fracturing techniques, which utilize lighter-weight fracturing fluid during the entire hydraulic fracturing process. As an example, the techniques described herein increase fracture productivity by ensuring that the entire fractured region (or at least a substantial portion thereof) is packed with proppant particulates. As another example, the techniques described herein enable conventional proppant particulates, including high-density sand, to be used for the hydraulic fracturing process without the potential issues previously discussed. This is further advantageous because sand is not only inexpensive but, when effectively placed, has been proven to provide proppant packs that maintain high porosity and permeability characteristics over the effective life of a typical wellbore. As another example, the techniques described herein enable sand (or other proppant particulates) with larger particle sizes to be used, which is more cost-effective and will also further increase the porosities and permeabilities of the resulting proppant packs. Further, the techniques described herein can reduce the total amount of proppant particulates that are needed to prop the fractures since the proppant is more effectively and evenly distributed throughout the fractures. As yet another example, the techniques described herein reduce the total amount of fracturing fluid that is needed to set the same propped area compared to conventional fracturing fluids, thus further increasing the efficiency and cost-effectiveness of the overall hydraulic fracturing process.

### Exemplary Hydrocarbon Well Completed Using Density-Tunable Aqueous Heavy Fracturing Fluid

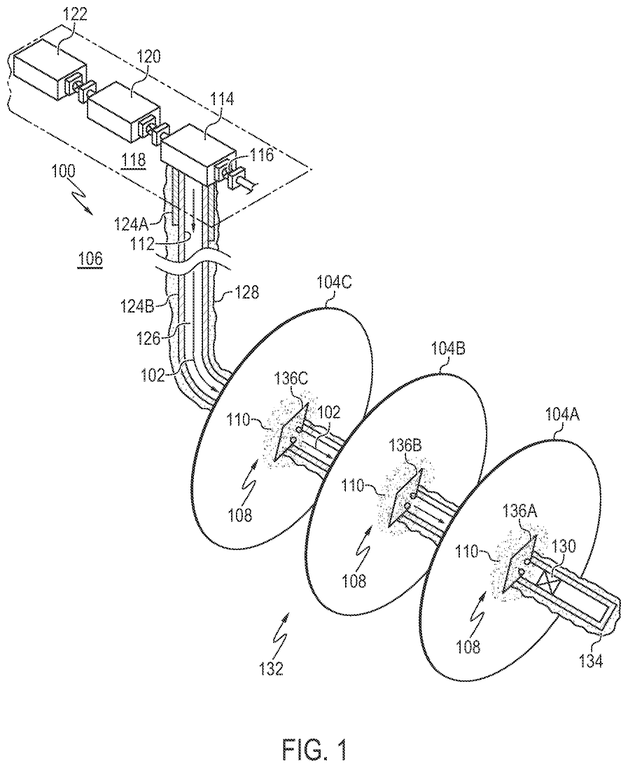

FIG. 1 is a schematic view of an exemplary hydrocarbon well 100 that is completed using the density-tunable aqueous heavy fracturing fluid described herein. In particular, FIG. 1 illustrates the hydrocarbon well 100 during an initial stage of the hydraulic fracturing operation, during which a conventional fracturing fluid, as indicated by arrow 102, is used to generate fractures 104A, 104B, and 104C within a subsurface region 106 including a hydrocarbon-bearing subterranean formation (or reservoir) and to partially prop a near-perforation region 108 of the fractures 104 with proppant particulates 110.

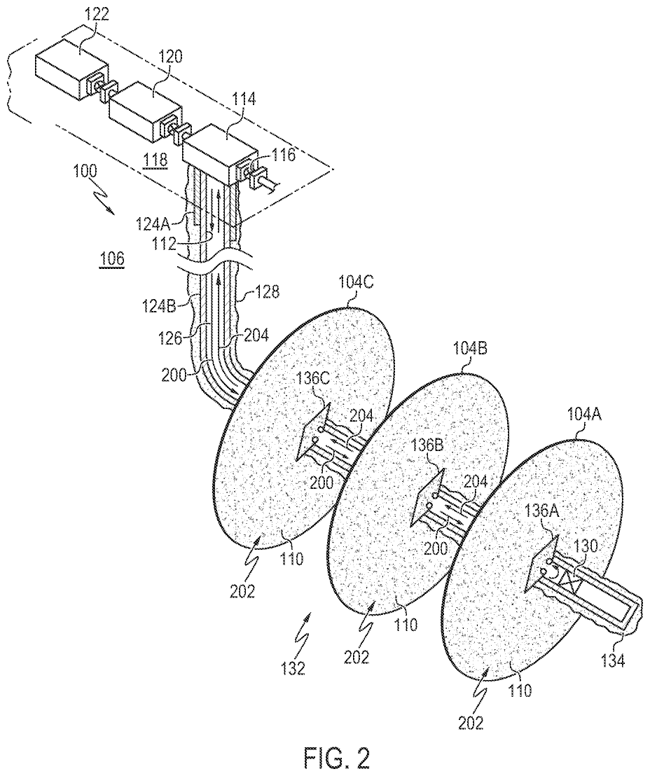

As shown in FIG. 1, the exemplary hydrocarbon well 100 includes a wellbore 112 that extends within the subsurface region 106 including the hydrocarbon-bearing subterranean formation (or reservoir). In some embodiments, the subterranean formation is an unconventional formation, such as a formation including, but not limited to, tight sandstone, shale, clay-rich mudstone, sand-rich mudstone, carbonate, and/or siliciclastic mudstone. The hydrocarbon well 100 also includes a wellhead 114 including (among other components) a shut-in valve 116 that controls the flow of hydrocarbon fluids from the subsurface region 106 to a surface region 118. In various embodiments, the wellhead 114 is physically and fluidically coupled to a fracturing fluid supply system 120 and a fracturing fluid recovery system 122, as described further with respect to FIG. 2.

The hydrocarbon well 100 is completed by setting a series of tubulars into the wellbore 112. These tubulars include several strings of casing, such as a surface casing string 124A and a production casing string 124B, as shown in FIG. 1, which define a tubular conduit 126 that provides a flow path for the hydrocarbon fluids to flow from the subsurface region 106 to the surface region 118. In some embodiments, additional intermediate casing strings (not shown) are also included to provide support for the walls of the wellbore 112. As shown in FIG. 1, the surface casing string 124A and the production casing string 124B are both hung from the surface. However, in various other aspects, the surface casing string 124A is hung from the surface, while the production casing string 124B (sometimes referred to as a “production liner”) is hung from the bottom of a preceding casing string (e.g., an intermediate casing string) using a liner hanger (not shown).

In various embodiments, the surface casing string 124A and the production casing string 124B (as well any intermediate casing strings) are set in place using cement 128. The cement 128 isolates the intervals of the subterranean formation from the wellbore 112 and each other. Alternatively, the wellbore 112 may be set as an open-hole completion, meaning that the production casing string 124B (or production liner) is not set in place using cement.

In some embodiments, the subterranean formation surrounding the wellbore 112 is hydraulically fractured via a plug-and-perforation (or “plug-and-perf”) process (or other suitable multistage hydraulic fracturing process). To implement this plug-and-perf process, a bottom hole assembly (BHA) (not shown) including perforating guns (not shown), a fracturing plug (or “frac plug”) 130, and a setting tool (not shown) is run to a desired depth or zone within the wellbore 112, where the desired depth or zone corresponds to a specific stage 132 of the hydrocarbon well 100. Once the desired depth or zone is reached, the setting tool is used to set the frac plug 130 against the inner diameter of the production casing string 124B, as shown with respect to the stage 132 depicted in the simplified schematic view of FIG. 1, which is the stage closest to a toe 134 of the wellbore 112. Once the frac plug 130 has been set within the production casing string 124B, the perforating guns are detonated to create clusters of perforations 136A, 136B, and 136C through the production casing string 124B and the surrounding cement 128.

The plug-and-perf assembly is then removed from the wellbore 112, and a conventional fracturing fluid is pumped down the wellbore 112, through the clusters of perforations 136A, 136B, and 136C, and into the surrounding formation, forming corresponding fractures 104A, 104B, and 104C within the formation. Next, a slurry of the conventional fracturing fluid and proppant particulates 110 is pumped down the wellbore 112, as indicated by the arrow 102, such that the proppant particulates 110 are positioned within the near-perforation region 108 of each fracture 104A, 104B, and 104C, with the effective reach and/or depth of the proppant particulates 110 varying based on the conditions within the fractures 104A, 104B, and 104C. In this manner, the proppant 110 serves to hold the near-perforation region of the fractures 104A, 104B, and 104C open after the hydraulic pressure is released.

According to one or more aspects described herein, the conventional proppant particulates may be included in slickwater or any other suitable fracturing fluid that is commercially available. The proppant particulates 110 may include a conventional proppant, such as sand, crushed granite, ceramic beads, and/or other granular materials. Additionally or alternatively, the proppant particulates 110 may include an unconventional, lightweight proppant, such as a proppant particulates including petroleum coke particles (e.g., delayed coke, fluid coke, or Flexicoke), polyolefins, and/or polyaromatic hydrocarbon resins.

In various embodiments, this plug-and-perf process is used to perforate and fracture a number of additional stages (not shown) corresponding to the horizontal portion of the wellbore 112, thus forming a number of corresponding perforation clusters and fractures. However, in many cases, difficulties are encountered during the hydraulic fracturing process. In particular, as shown schematically in FIG. 1, the proppant 110 tends to deposit (or settle) within the near-perforation region 108 of the fractures 104A, 104B, and 104C, which is the area of the fractures 104A, 104B, and 104C that is in relatively close proximity to the corresponding perforations and/or within the perforation tunnels themselves. As described herein, this problem is caused, at least in part, by the high settling velocity of the relatively high-density proppant particulates 110 within relatively low-density conventional fracturing fluid, where such settling velocity is directly correlated to the density difference between the proppant particulates 110 and the fracturing fluid, with a higher density difference between the proppant particulates 110 and the fracturing fluid resulting in the higher settling velocity. Moreover, such settling of the proppant particulates 110 within primarily the near-perforation region 108 of the formation prevents the hydraulic fracturing process from effectively maximizing the propped fracture surface area, thus resulting in limited production from the resulting low-conductivity, partly-unpropped fractures 104A, 104B, and 104C.

Therefore, according to the various aspects of the present disclosure, rather than using a conventional fracturing fluid, a density-tunable aqueous heavy fracturing fluid is used to increase the effectiveness of the hydraulic fracturing process. In particular, FIG. 2 is another schematic view of the exemplary hydrocarbon well 100 of FIG. 1, which is completed using the density-tunable aqueous heavy fracturing fluid described herein. FIG. 2 illustrates the exemplary stage 132 of the hydrocarbon well 100 during a final part of the hydraulic fracturing operation for the particular stage 132, during which a slurry including the density-tunable aqueous heavy fracturing fluid and proppant particulates is flowed into the wellbore 112, as indicated by arrow 200, and used to further prop both the near-perforation region 108 (FIG. 1) and an extended region 202 of the fractures 104A, 104B, and 104C with the proppant 110. Those skilled in the art will appreciate that, while the density-tunable aqueous heavy fracturing fluid is described as providing for the effective propping of the extended region 202 of the fractures 104A, 104B, and 104C, the effective reach and/or depth of the proppant particulates 110 will vary based on the conditions within the fractures 104A, 104B, and 104C. In general, the utilization of the density-tunable aqueous heavy fracturing fluid may enable the deposition of the proppant particulates 110 within substantially the entire length of each fracture 104A, 104B, and 104C or some substantial portion thereof, such as, for example, about 70% to about 90% of the total length of each fracture 104A, 104B, and 104C.

In various embodiments, the hydrocarbon well 100 also includes the fracturing fluid supply system 120 for providing the slurries including the conventional fracturing fluid and the density-tunable aqueous heavy fracturing fluid to the subsurface region 106 via the tubular conduit 126 corresponding to the production casing string 124B. In one or more aspects, as shown in FIG. 2, the fracturing fluid supply system 120 provides the density-tunable aqueous heavy fracturing fluid to the wellhead 114, and the wellhead 114 then provides the density-tunable aqueous heavy fracturing fluid to the tubular conduit 126. However, in other aspects, the fracturing fluid supply system 120 provides the density-tunable aqueous heavy fracturing fluid directly to the tubular conduit 126. Moreover, once the density-tunable aqueous heavy fracturing fluid has been provided to the tubular conduit 126, the density-tunable aqueous heavy fracturing fluid flows to the perforations 136A, 136B, and 136C and into the near-perforation region of the corresponding fractures 104A, 104B, and 104C, as indicated by the arrow 200.

In some aspects, the fracturing fluid supply system 120 includes an aqueous solution supply tank for storing one or more aqueous carrier fluids comprising one or more soluble compounds. In addition, the fracturing fluid supply system may include a proppant particulates storage tank for storing one or more types of proppant. In such embodiments, the fracturing fluid supply system 120 is configured to blend aqueous carrier fluids comprising soluble compound(s) and/or the proppant particulates to form suitable slurries to be used as the density-tunable aqueous heavy fracturing fluid described herein. In particular, the fracturing fluid supply system 120 may be configured to blend or mix such components to provide density-tunable aqueous heavy fracturing fluid with a specified density. In various aspects, the specified density of the density-tunable aqueous heavy fracturing fluid is between 1 g/cc and 3.6 g/cc, such as about 1.2 g/cc to about 3.6 g/cc, or 1.25 g/cc to about 3.4 g/cc, encompassing any value and subset therebetween. Moreover, in various aspects, the density of the density-tunable aqueous heavy fracturing fluid is specifically selected based on the density of the selected proppant particulates, whether of uniform composition or a blended composition.

In some embodiments, the density of the density-tunable aqueous heavy fracturing fluid may then be adjusted as the hydraulic fracturing operation progresses to achieve a specified settling velocity for the proppant within the slurry, where such specified settling velocity may be determined (and then intermittently modified) to ensure substantially even placement of the proppant within both the near-perforation and extended regions of the fractures. For example, the density of the density-tunable aqueous heavy fracturing fluid may be selected to within ±20% of the density of the proppant particulates, depending on the details of the particular implementation. Moreover, in some aspects, the density of the density-tunable aqueous heavy fracturing fluid is gradually increased to encourage the proppant to settle further and further from the wellbore within the extended region of the fractures.

In addition, in some aspects, the fracturing fluid supply system 120 also includes one or more fracturing fluid supply conduits (not shown) that are configured to separately provide the conventional fracturing fluid and the density-tunable aqueous heavy fracturing fluid to the subsurface region 106 via the tubular conduit 126. In some such embodiments, the fracturing fluid supply system 120 further includes one or more fracturing fluid pumps (not shown) that provide a motive force for supplying the conventional fracturing fluid and the density-tunable aqueous heavy fracturing fluid to the subsurface region 106.

It is within the scope of the present disclosure that the fracturing fluid supply system 120 may include one or more additional pipes, conduits, valves, controllers, and/or other fluid flow-control devices that may be incorporated into the fracturing fluid supply system 120 in any suitable manner. Such additional pipes, conduits, valves, controllers, and/or other fluid flow-control devices may be used to, for example, control and/or regulate the flow (or flow rates) of fluid streams, either by manual or electronic means, such as the slurries including the conventional fracturing fluid, the density-tunable aqueous heavy fracturing fluid, and/or the proppant particulates, to the subsurface region 106.

Furthermore, in various aspects, the hydrocarbon well 100 also includes the fracturing fluid recovery system 122, which is configured to recover at least a portion of the density-tunable aqueous heavy fracturing fluid from a slurry including the density-tunable aqueous heavy fracturing fluid and conventional fracturing fluid (as well as any residual proppant particulates and/or other fluids) flowing back to the wellhead 114 after the stage 132 has been hydraulically fractured. In such embodiments, the fracturing fluid recovery system 122 may include a system for generating artificial lift in order to lift the slurry (as well as any residual proppant particulates and/or other fluids). In further embodiments, the fracturing fluid recovery system 122 may include any type(s) of separation device(s) that are configured to separate the density-tunable aqueous heavy fracturing fluid from the conventional fracturing fluid (as well as any residual proppant particulates and/or other fluids). For example, in some embodiments, the separation device(s) is configured to recover at least 60%, at least 70%, at least 80%, or at least 90% of the density-tunable aqueous heavy fracturing fluid that flows back to the wellhead 114, encompassing any value and subset therebetween. Moreover, because the slurry including the density-tunable aqueous heavy fracturing fluid is flowed into the fractures 104A, 104B, and 104C during the final part of the hydraulic fracturing process, a substantial portion of the density-tunable aqueous heavy fracturing fluid will flow back to the wellhead 114 during the initial flowback. For example, in some embodiments, at least 50%, at least 60%, or at least 70% of the total volume of density-tunable aqueous heavy fracturing fluid that is pumped into the wellbore 112 will return to the wellhead 114.

Moreover, in some aspects, the fracturing fluid recovery system 122 includes a fracturing fluid reconditioning unit, which is configured to recondition the density-tunable aqueous heavy fracturing fluid (and/or the components thereof) for reuse within the wellbore 112 and/or another wellbore. According to various aspects described herein, capturing the density-tunable aqueous heavy fracturing fluid for reconditioning and reuse in this manner helps to increase the overall efficiency and cost-effectiveness of the hydraulic fracturing process (or future hydraulic fracturing processes).

The schematic views of FIGS. 1 and 2 are not intended to indicate that the hydrocarbon well 100 is to include all of the components shown in FIGS. 1 and 2, or that the hydrocarbon well 100 is limited to only the components shown in FIGS. 1 and 2. Rather, any number of components may be omitted from the hydrocarbon well 100 or added to the hydrocarbon well 100, depending on the details of the specific implementation. Moreover, those skilled in the art will appreciate that, while the hydrocarbon well 100 is depicted as including only one stage, this is for ease of illustration only. In practice, the hydrocarbon well 100 may include, for example, around 20 to 100 individual stages, with each stage including around 3 to 20 perforation clusters, where each perforation cluster typically includes a series of around 12 to 18 perforations extending over a 1-foot to 3-foot region, and where each zone is typically separated by around 10 to 100 feet along the length of the wellbore 112. Furthermore, those skilled in the art will appreciate that, while the hydrocarbon well 100 is depicted as including a vertical section and a horizontal section, the hydrocarbon well 100 may include any number of additional or alternative lateral, deviated, and/or highly-deviated sections extending in various directions throughout the subsurface region 106. In addition, in some aspects, the wellhead 114 is a splitter-type wellhead that connects to a number of wellbores within the subsurface region 106.

### Exemplary Properties of Density-Tunable Aqueous Heavy Fracturing Fluid

The present techniques provide for the utilization of a density-tunable aqueous heavy fracturing fluid as a carrier fluid for efficiently propping a fractured subsurface region with proppant particulates. Specifically, utilizing a relatively heavy (or high-density) fracturing fluid serves to reduce the settling velocity of the proppant particulates within the fluid. In particular, because the settling rate (e.g., the settling velocity, as shown in expressions for both Stokes terminal settling velocity and Ferguson & Church settling velocity) of the proppant particulates is proportional to the difference in density between the proppant particulates and the carrier fluid, utilizing a heavier (e.g., higher-density) carrier fluid according to embodiments described herein enables the proppant particulates to stay suspended for a longer period of time during the hydraulic fracturing process, thus increasing the overall fracturing potential for the process and extending the effective reach and/or depth for depositing the proppant particulates within the resulting fractures. This concept is illustrated by equation (1), which may be used to determine the rate of settling (or settling velocity), v, for a proppant particle.

$$v = \frac{{ρ}_{p} - {ρ}_{f}}{c η} g {σ}^{2} , \qquad ( 1 )$$

In equation (1), ρₚ−ρ_{f} is the density difference between the proppant particulate and the carrier fluid; c is the unit constant; η is the viscosity of the carrier fluid; g is the gravitational constant; and σ² is the square of the proppant particulate diameter. As will be appreciated, proppant particulates will settle at a slower rate as the density of the carrier fluid approaches the particle density and, accordingly, will also have better transport characteristics within such carrier fluid.

Turning now to exemplary details regarding the composition of the density-tunable aqueous heavy fracturing fluids described herein, such density-tunable aqueous heavy fracturing fluids include one or more aqueous carrier fluids comprising one or more soluble compounds. The aqueous carrier fluids, in some aspects, may be solutions of the one or more soluble compounds.

For embodiments in which the density-tunable aqueous heavy fracturing fluid includes one or more aqueous carrier fluids comprising one or more soluble compounds, such soluble compound(s) may include, for example, bromine-based compounds and chlorine-based compounds such as zinc bromide, cesium bromide, calcium bromide, sodium bromide, calcium chloride, sodium chloride, and any combinations thereof. Some aspects of the present disclosure may also include formate-based compounds including cesium formate. The density-tunable aqueous heavy fracturing fluids can have tunable densities of up to about 3.6 g/cc or even higher, depending on the concentration of the soluble compound(s), such as in the range of about 1 g/cm³ to about 3.6 g/cm³, encompassing any value and subset therebetween. In addition, such density-tunable aqueous heavy fracturing fluid may have low viscosities.

For example, the density-tunable aqueous heavy fracturing fluids of the present disclosure may have a viscosity in the range of about 1.5 cP to about 5 cP at 25° C., with the viscosity decreasing as temperature increases. Moreover, the density-tunable aqueous heavy fracturing fluids may exhibit high thermal stability, as demonstrated by testing at 95° C. for over two weeks with no observable change. Furthermore, such fluids may have advantageously low toxicity levels and may be non-damaging to subterranean formations. The settling velocity of the density-tunable aqueous heavy fracturing fluids of the present disclosure may be in the range of, for example, about 0.1 ft/min to about 12 ft/min for proppant particulates having an average diameter in the range of about 100 μm to about 425 μm at a fluid density of about 1.5 g/cc. It will be appreciated that the settling velocity of the density-tunable aqueous heavy fracturing fluids of the present disclosure will be affected by the proppant particulate average diameter as well as the density of the density-tunable aqueous heavy fracturing fluid.

Stated more generally, the density-tunable aqueous heavy fracturing fluid described herein may be a relatively-high-density fluid, such as an aqueous carrier fluid comprising one or more soluble compounds and further comprising proppant particulates. As described herein, the utilization of such fluids (or any suitable combination thereof) provides a heavy fracturing fluid including a density that more closely approximates the density of the proppant as compared to conventional fracturing fluid and, thus, provides for more even and efficient placement of the proppant within the extended regions of the fractures for each stage of the wellbore. Referring now to the general formulation of the density-tunable aqueous heavy fracturing fluid described herein, the density-tunable aqueous heavy fracturing fluid comprises an aqueous carrier fluid comprising one or more soluble compounds, and may further comprise proppant particulates. The aqueous carrier fluids may include, but are not limited to, fresh water, saltwater (including seawater), treated water (e.g., treated production water, treated wastewater), other forms of aqueous fluid, and any combination thereof. As provided above, the one or more soluble compounds include bromide-based compounds, chloride-based compounds, and/or formate-based compounds. In one or more aspects, the density-tunable aqueous heavy fracturing fluid comprises at least a bromide-based compound (e.g., zinc bromide).

As previously mentioned, the density-tunable aqueous heavy fracturing fluids of the present disclosure may permit the use of larger proppant particulates than are conventionally used, although conventionally sized proppants are also suitable. For use in the density-tunable aqueous heavy fracturing fluids described herein, the proppant particulates may have an average diameter in the range of about 90 micrometers (μm) to about 600 μm, encompassing any value and subset therebetween. Conventional proppant particulates used for fracturing operations are generally less than 850 μm, thus in some instances the proppant particulates used in the present disclosure may be greater than 90 μm and up to 600 μm, encompassing any value and subset therebetween. The proppant particulates forming part of the density-tunable aqueous heavy fracturing fluids described herein may be any shape, such as spherical, substantially spherical, ovoid, polygonal, or otherwise irregular in shape.

For use in the in the density-tunable aqueous heavy fracturing fluids described herein, the proppant particulates may have an average density in the range of about 1 g/cc to about 3.6 g/cc, encompassing any value and subset therebetween, such as about 1.2 g/cc to about 2.7 g/cc.

In general, the proppant particulates are included in the density-tunable aqueous heavy fracturing fluids of the present disclosure in a range of about 2.5 vol. % to about 20 vol. % of the density-tunable aqueous have fracturing fluids (aqueous carrier fluid, soluble compound(s), and any additional additive(s)), encompassing any value and subset therebetween.

Various optional additives may be included in the density-tunable aqueous heavy fracturing fluids of the present disclosure including, but not limited to, diluent aids, biocides, breakers, corrosion inhibitors, crosslinkers, friction reducers (e.g., polyacrylamides), gels, salts (e.g., KCl), oxygen scavengers, pH control additives, scale inhibitors, surfactants, weighting agents, inert solids, fluid loss control agents, emulsifiers, emulsion thinners, emulsion thickeners, defoamers, viscosifying agents, particles, lost circulation materials, buffers, stabilizers, chelating agents, mutual solvents, oxidizers, reducers, clay stabilizing agents, and any combination thereof.

The density-tunable aqueous heavy fracturing fluid may be provided with a density of between around 1 g/cc and 3.6 g/cc. According to various aspects described herein, the density of the density-tunable aqueous heavy fracturing fluid is specifically determined or selected based, at least in part, on the density of the proppant particulates provided therein. For example, in some embodiments, the density of the density-tunable aqueous heavy fracturing fluid is selected to be within ±20% of the density of the proppant particulates, although the exact density difference between the aqueous carrier fluid and the proppant particulates within the density-tunable aqueous heavy fracturing fluid may vary depending on the details of the specific implementation. Moreover, in various embodiments, the density of the density-tunable aqueous heavy fracturing fluid is adjusted (or “tuned”) to achieve a specified settling velocity for the proppant particulates therein, with a lower density difference between the fracturing fluid and the proppant being selected to achieve a lower settling velocity. In such embodiments, the settling velocity may be determined to ensure substantially even placement of the proppant particulates within both the near-perforation region and the extended region of the fractures. In addition, in some aspects, the density of the density-tunable aqueous heavy fracturing fluid is gradually increased to encourage the proppant to settle further and further from the wellbore within the extended region of the fractures. The adjustment in density of the density-tunable aqueous heavy fracturing fluid can be performed on-the-fly, while the fracturing operation is being performed.

Those skilled in the art will appreciate that the properties and characteristics of the density-tunable aqueous heavy fracturing fluid described herein will vary based on the particular combination of aqueous carrier fluid(s), soluble compound(s), and proppant particulates utilized to form the density-tunable aqueous heavy fracturing fluid. In some embodiments, this variability may be utilized to customize the properties of the density-tunable aqueous heavy fracturing fluid, such as, in particular, the density properties of the fluid, based on the details of the specific implementation.

Method for Completing Hydrocarbon Well Using Density-Tunable Aqueous Heavy Fracturing Fluid

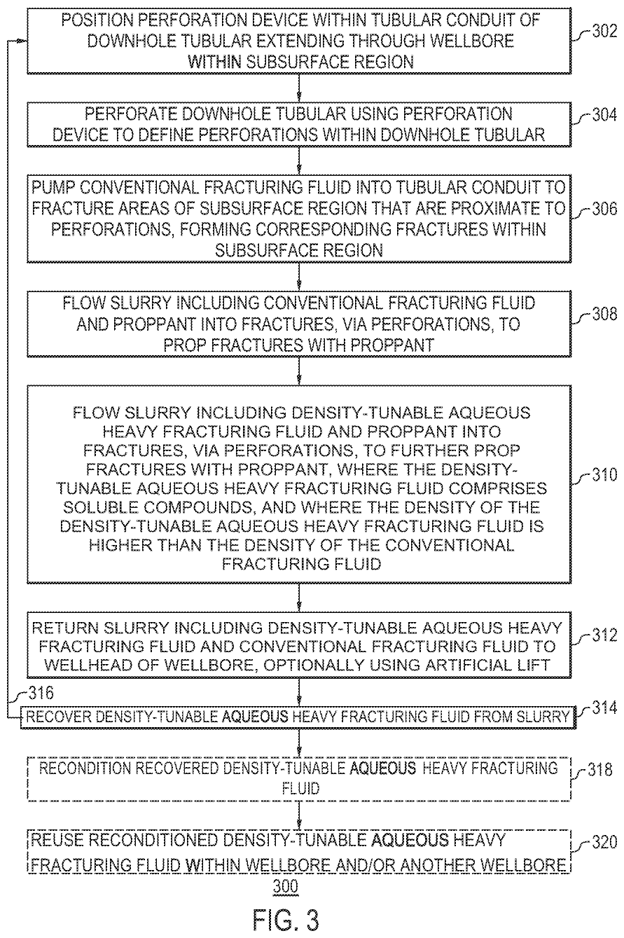

FIG. 3 is a process flow diagram of an exemplary method 300 for completing a hydrocarbon well (such as the exemplary hydrocarbon well 100 described with respect to FIGS. 1 and 2) using the density-tunable aqueous heavy fracturing fluid described herein. The method 300 begins at block 302, at which a perforation device is positioned within a tubular conduit of a downhole tubular extending through a wellbore within a subsurface region. This may be performed in any suitable manner. As an example, the perforation device may be flowed in a downhole direction and/or within a conveyance fluid stream that may be provided to the tubular conduit. As another example, an umbilical may be utilized to position the perforation device within the tubular conduit and/or to retain the perforation device within a target (or desired) region of the tubular conduit. As another example, the umbilical may be utilized to pull the perforation device in an uphole direction to position the perforation device within the tubular conduit and/or within the target region of the tubular conduit. Examples of a suitable umbilical for this purpose include a slickline, a wireline, coiled tubing, and/or a workover string.

At block 304, the downhole tubular is perforated using the perforation device to define (or create) perforations within the downhole tubular. This may be accomplished in any suitable manner. As an example, the perforation device may include and/or be a shaped charge perforation device that includes shaped charges. In this example, the downhole tubular may be perforated by igniting and/or discharging at least a subset of the shaped charges to form and/or define the perforations within the downhole tubular.

At block 306, conventional fracturing fluid is pumped into the tubular conduit to fracture areas of the subsurface region that are proximate to the perforations, forming corresponding fractures within the subsurface region. In some aspects, this may include flowing the conventional fracturing fluid into the tubular conduit while sequentially increasing and decreasing the pumping rate, thus inducing a number of pressure cycles within the wellbore. Such pressure cycles, in turn, help to force the conventional fracturing fluid into the subsurface region via the perforations, locally pressurizing the subsurface region such that the fractures are formed within the subsurface region.

At block 308, a slurry including the conventional fracturing fluid and proppant particulates is flowed into at least a portion of the fractures, via the perforations, to prop the fractures with the proppant. In various embodiments, the propping at block 308 involves depositing the proppant within primarily the near-perforation region of the fractures. This is due, at least in part, to the relatively high settling velocity of the proppant within the conventional fracturing fluid.

Accordingly, at block 310, a slurry including the density-tunable aqueous heavy fracturing fluid described herein and the proppant is flowed into the fractures, via the perforations, to further prop the fractures with the proppant, where the density-tunable aqueous heavy fracturing fluid includes one or more aqueous carrier fluids having one or more soluble compounds, and where the density of the density-tunable aqueous heavy fracturing fluid is higher than the density of the conventional fracturing fluid. As described herein, the propping at block 310 involves depositing the proppant particulates within, not only the near-perforation region of the fractures, but also the extended region of the fractures. This is due, at least in part, to the lower settling velocity of the proppant particulates within the density-tunable aqueous heavy fracturing fluid.

In some embodiments, block 310 further includes selecting the density of the density-tunable aqueous heavy fracturing fluid based, at least in part, on the density of the proppant. In such embodiments, block 310 may also include selecting the density of the density-tunable aqueous heavy fracturing fluid to be within (±) 20% of the density of the proppant, including within (±) 10% of the density of the proppant, or within (±) 5% of the density of the proppant particulates, depending on the details of the particular implementation. In addition, in some embodiments, block 310 includes adjusting the density of the density-tunable aqueous heavy fracturing fluid to achieve a specified settling velocity for the proppant. In such embodiments, block 310 may also include gradually increasing the density of the density-tunable aqueous heavy fracturing fluid to encourage the proppant to settle further from the wellbore within the extended region of the fractures. Furthermore, in some embodiments, block 310 also includes providing the density-tunable aqueous heavy fracturing fluid with a density of between 1 g/cc and 3.6 g/cc.

At block 312, a slurry including the density-tunable aqueous heavy fracturing fluid and some amount of the conventional fracturing fluid is returned (or flowed back) to the wellhead of the wellbore. In various embodiments, this is accomplished by first allowing the hydraulic pressure within the wellbore to dissipate and then putting the hydrocarbon well onto production. As flowback begins, the first fluid flowing to the surface will be concentrated in the density-tunable aqueous heavy fracturing fluid, which was the last fluid pumped into the wellbore during the hydraulic fracturing process. In some embodiments, block 312 may include injecting gas into the wellbore for the purpose of generating artificial lift in order to lift the slurry (as well as any residual proppant and/or other fluids), as described hereinabove. Accordingly, the slurry flowing back from the wellbore will include a substantial portion of the density-tunable aqueous heavy fracturing fluid and some amount of the conventional fracturing fluid, as well as any residual proppant and/or other fluids from the wellbore.

At block 314, at least a portion of the density-tunable aqueous heavy fracturing fluid is recovered from the slurry. In some embodiments, this is accomplished by flowing the slurry through one or more separation devices that are configured to separate the density-tunable aqueous heavy fracturing fluid from the conventional fracturing fluid (as well as any residual proppant and/or other fluids). Moreover, in some aspects, the residual proppant particulates (if any) may not be separated from the density-tunable aqueous heavy fracturing fluid but, rather, may remain within the fracturing fluid until it is reused.

Moreover, as indicated by arrow 316, blocks 302-314 of the method 300 may be repeated any number of times. In various embodiments, this includes repeating blocks 302-314 for each stage of the hydrocarbon well (or for at least a portion of such stages) as the hydraulic fracturing operation progresses.

Furthermore, at optional block 318, the recovered density-tunable aqueous heavy fracturing fluid may be reconditioned. For example, if the slurry flowing back from the wellbore includes around 90% density-tunable aqueous heavy fracturing fluid and around 10% conventional fracturing fluid, the recovered density-tunable aqueous heavy fracturing fluid may be diluted. Therefore, fine particles (and/or other solids or fluids) may be added back into the density-tunable aqueous heavy fracturing fluid during reconditioning to render the density-tunable aqueous heavy fracturing fluid suitable for reuse. Moreover, after such reconditioning, the reconditioned density-tunable aqueous heavy fracturing fluid may be reused within the wellbore and/or another wellbore at optional block 320.

The process flow diagram of FIG. 3 is not intended to indicate that the steps of the method 300 are to be executed in any particular order, or that all of the steps of the method 300 are to be included in every case. Further, any number of additional steps not shown in FIG. 3 may be included within the method 300, depending on the details of the specific implementation. As an example, in some embodiments, the method 300 includes formulating the density-tunable aqueous heavy fracturing fluid based, at least in part, on expected or measured downhole conditions within the subsurface region.

### Example Embodiments

Nonlimiting example embodiments of the present disclosure include the following.

Embodiment A: A slurry for propping fractures within a subsurface region, wherein the slurry comprises: proppant particulates; and a density-tunable aqueous heavy fracturing fluid comprising an aqueous carrier fluid and at least a bromide-based compound; wherein the density of the density-tunable aqueous heavy fracturing fluid is selected based on a density of the proppant particulates such that density of the density-tunable aqueous heavy fracturing is within 20% of the density of the proppant particulates.

Embodiment B: A method for completing a hydrocarbon well using a density-tunable aqueous heavy fracturing fluid, the method comprising: flowing a slurry comprising a density-tunable aqueous heavy fracturing fluid and proppant particulates into a wellbore to prop fractures with the proppant particulates, wherein the density-tunable aqueous heavy fracturing fluid comprises an aqueous carrier fluid and at least a bromide-based compound, wherein a density of the density-tunable aqueous heavy fracturing fluid is selected based on a density of the proppant particulates such that density of the density-tunable aqueous heavy fracturing is within 20% of the density of the proppant particulates; returning the slurry comprising the density-tunable aqueous heavy fracturing fluid to a wellhead of the wellbore; and recovering at least a portion of the density-tunable aqueous heavy fracturing fluid from the slurry.

Embodiment C: A method for completing a hydrocarbon well using an density-tunable aqueous heavy fracturing fluid, the method comprising: positioning a perforation device within a tubular conduit of a downhole tubular extending through a wellbore within a subsurface region; perforating the downhole tubular using the perforation device to define perforations within the downhole tubular; pumping a conventional fracturing fluid into the tubular conduit to fracture areas of the subsurface region that are proximate to the perforations, forming corresponding fractures within the subsurface region; flowing a slurry comprising the conventional fracturing fluid and first proppant particulates into the fractures, via the perforations, to prop the fractures with the first proppant particulates; flowing a slurry comprising the density-tunable aqueous heavy fracturing fluid and second proppant particulates into the fractures, via the perforations, to further prop the fractures with the second proppant particulates, wherein the density-tunable aqueous heavy fracturing fluid comprises an aqueous carrier fluid and at least a bromide-based compound, and wherein a density of the density-tunable aqueous heavy fracturing fluid is higher than a density of the conventional fracturing fluid, and wherein the density of the density-tunable aqueous heavy fracturing fluid is selected based on a density of the proppant particulates such that density of the density-tunable aqueous heavy fracturing is within 20% of the density of the proppant particulates; returning the slurry comprising the density-tunable aqueous heavy fracturing fluid and the conventional fracturing fluid to a wellhead of the wellbore; and recovering at least a portion of the density-tunable aqueous heavy fracturing fluid from the slurry.

Nonlimiting example embodiments A, B, or C may include one or more of the following elements.

Element 1: Wherein the bromide-based compound comprises at least one of: zinc bromide, cesium bromide, calcium bromide, sodium bromide, or any combination thereof.

Element 2: Wherein the bromide-based compound comprises zinc bromide.

Element 3: Wherein the density-tunable aqueous heavy fracturing fluid further comprises at least one of: calcium chloride, sodium chloride, cesium formate, or any combination thereof.

Element 4: Wherein the density-tunable aqueous heavy fracturing fluid has a density in the range of 1 grams per cubic centimeter (g/cc) and 3.6 g/cc.

Element 5: Wherein the proppant particulates have an average diameter in the range of 90 micrometers (μm) to 600 μm.

Element 6: Wherein the proppant particulates are composed of at least one of: sand, ceramic, petroleum coke, a polyolefin, a polyaromatic hydrocarbon resin, or any combination thereof.

Element 7: Wherein the proppant particulates have a density in the range of 1.2 grams per cubic centimeter (g/cc) and 3 g/cc.

Embodiments A, B, and C may each have any one, more, or all of Elements 1-7 in any combination.

Embodiment B may include one or more of the following elements, in addition to Elements 1-7 singly or in any combination:

Element 8: Further comprising flowing a gas into the hydrocarbon well, wherein the gas generates artificial lift in order to lift the slurry.

Element 9: Wherein flowing the slurry comprising the density-tunable aqueous heavy fracturing fluid and the proppant particulates into the fractures further comprises adjusting the density of the density-tunable aqueous heavy fracturing fluid to achieve a specified settling velocity for the proppant particulates.

Element 10: Wherein flowing the slurry comprising the density-tunable aqueous heavy fracturing fluid and the proppant particulates into the fractures further comprises adjusting the density of the density-tunable aqueous heavy fracturing fluid to achieve a specified settling velocity for the proppant particulates, and wherein adjusting the density of the density-tunable aqueous heavy fracturing fluid comprises gradually increasing the density of the density-tunable aqueous heavy fracturing fluid to encourage the proppant to settle further from the wellbore within an extended region of the fractures.

Element 11: Further comprising: reconditioning the recovered density-tunable aqueous heavy fracturing fluid; and reusing the reconditioned density-tunable aqueous heavy fracturing fluid within at least one of the wellbore or another wellbore.

Element 12: Further comprising formulating the density-tunable aqueous heavy fracturing fluid based, at least in part, on expected or measured downhole conditions within the subsurface region.

Element 13: Comprising performing the method for each stage of the wellbore.

Embodiment B may have any one, more, or all of Elements 1-13 in any combination.

Embodiment C may have any of Elements 1-10, 12, 13, and Element 14 below in any combination.

Element 14: Further comprising reusing the reconditioned density-tunable aqueous heavy fracturing fluid within at least one of the wellbore or another wellbore.

Unless otherwise indicated, all numbers expressing quantities of ingredients, properties such as molecular weight, reaction conditions, and so forth used in the present specification and associated claims are to be understood as being modified in all instances by the term “about,” and take into account experimental error and variations that would be expected by a person having ordinary skill in the art. Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

What is claimed is:

1. A slurry for propping fractures within a subsurface region, wherein the slurry comprises:
proppant particulates; and
a density-tunable aqueous heavy fracturing fluid comprising an aqueous carrier fluid and at least a bromide-based compound;
wherein the density of the density-tunable aqueous heavy fracturing fluid is selected based on a density of the proppant particulates such that density of the density-tunable aqueous heavy fracturing is within 20% of the density of the proppant particulates.

2. The slurry of claim 1, wherein the bromide-based compound comprises at least one of: zinc 10 bromide, cesium bromide, calcium bromide, sodium bromide, or any combination thereof.

3. The slurry of claim 1, wherein the bromide-based compound comprises zinc bromide.

4. The slurry of claim 1, wherein the density-tunable aqueous heavy fracturing fluid further comprises at least one of: calcium chloride, sodium chloride, cesium formate, or any combination thereof.

5. The slurry of claim 1, wherein the density-tunable aqueous heavy fracturing fluid has a density in the range of 1 grams per cubic centimeter (g/cc) and 3.6 g/cc.

6. The slurry of claim 1, wherein the proppant particulates have an average diameter in the range of 90 micrometers (μm) to 600 μm.

7. The slurry of claim 1, wherein the proppant particulates are composed of at least one of:
sand, ceramic, petroleum coke, a polyolefin, a polyaromatic hydrocarbon resin, or any combination thereof.

8. A method for completing a hydrocarbon well using a density-tunable aqueous heavy fracturing fluid, the method comprising:
flowing a slurry comprising a density-tunable aqueous heavy fracturing fluid and proppant particulates into a wellbore to prop fractures with the proppant particulates, wherein the density-tunable aqueous heavy fracturing fluid comprises an aqueous carrier fluid and at least a bromide-based compound, wherein a density of the density-tunable aqueous heavy fracturing fluid is selected based on a density of the proppant particulates such that density of the density-tunable aqueous heavy fracturing is within 20% of the density of the proppant particulates;
returning the slurry comprising the density-tunable aqueous heavy fracturing fluid to a wellhead of the wellbore; and
recovering at least a portion of the density-tunable aqueous heavy fracturing fluid from the slurry.

9. The method of claim 8, wherein the bromide-based compound comprises at least one of:
zinc bromide, cesium bromide, calcium bromide, sodium bromide, or any combination thereof.

10. The method of claim 8, wherein the bromide-based compound comprises zinc bromide.

11. The method of claim 8, wherein the density-tunable aqueous heavy fracturing fluid further comprises at least one of: calcium chloride, sodium chloride, cesium formate, or any combination thereof.

12. The method of claim 8, further comprising flowing a gas into the hydrocarbon well, wherein the gas generates artificial lift in order to lift the slurry.

13. The method of claim 8, wherein the proppant particulates have an average diameter of about 90 micrometers (μm) to about 600 μm.

14. The method of claim 8, wherein flowing the slurry comprising the density-tunable aqueous heavy fracturing fluid and the proppant particulates into the fractures further comprises adjusting the density of the density-tunable aqueous heavy fracturing fluid to achieve a specified settling velocity for the proppant particulates.

15. The method of claim 14, wherein adjusting the density of the density-tunable aqueous heavy fracturing fluid comprises gradually increasing the density of the density-tunable aqueous heavy fracturing fluid to encourage the proppant to settle further from the wellbore within an extended region of the fractures.

16. The method of claim 8, wherein the proppant particulates have a density in the range of 1.2 grams per cubic centimeter (g/cc) and 3 g/cc.

17. The method of claim 8, wherein the density-tunable aqueous heavy fracturing fluid has a density in the range of 1 gram per cubic centimeter (g/cc) and 3.6 g/cc.

18. The method of claim 8, further comprising:
reconditioning the recovered density-tunable aqueous heavy fracturing fluid; and
reusing the reconditioned density-tunable aqueous heavy fracturing fluid within at least one of the wellbore or another wellbore.

19. The method of claim 8, further comprising formulating the density-tunable aqueous heavy fracturing fluid based, at least in part, on expected or measured downhole conditions within the subsurface region.

20. The method of claim 8, comprising performing the method for each stage of the wellbore.

21. A method for completing a hydrocarbon well using a density-tunable aqueous heavy fracturing fluid, the method comprising:
positioning a perforation device within a tubular conduit of a downhole tubular extending through a wellbore within a subsurface region;
perforating the downhole tubular using the perforation device to define perforations within the downhole tubular;
pumping a conventional fracturing fluid into the tubular conduit to fracture areas of the subsurface region that are proximate to the perforations, forming corresponding fractures within the subsurface region;
flowing a slurry comprising the conventional fracturing fluid and first proppant particulates into the fractures, via the perforations, to prop the fractures with the first proppant particulates;
flowing a slurry comprising the density-tunable aqueous heavy fracturing fluid and second proppant particulates into the fractures, via the perforations, to further prop the fractures with the second proppant particulates, wherein the density-tunable aqueous heavy fracturing fluid comprises an aqueous carrier fluid and at least a bromide-based compound, and wherein a density of the density-tunable aqueous heavy fracturing fluid is higher than a density of the conventional fracturing fluid, and wherein the density of the density-tunable aqueous heavy fracturing fluid is selected based on a density of the proppant particulates such that density of the density-tunable aqueous heavy fracturing is within 20% of the density of the proppant particulates;
returning the slurry comprising the density-tunable aqueous heavy fracturing fluid and the conventional fracturing fluid to a wellhead of the wellbore; and
recovering at least a portion of the density-tunable aqueous heavy fracturing fluid from the slurry.

22. The slurry of claim 21, wherein the bromide-based compound comprises zinc bromide.

23. The slurry of claim 21, wherein the density-tunable aqueous heavy fracturing fluid has a density of between 1 grams per cubic centimeter (g/cc) and 3.6 g/cc.
